(19) United States
(12) Patent Application Publication
(10) Pub. No.: US 2008/0293380 A1
(43) Pub. Date: Nov. 27, 2008

(54) MESSEAGING SERVICE

(76) Inventor: Jim Anderson, Cortlandt Manor, NY (US)

Correspondence Address: FISH & RICHARDSON P.C., P.O. BOX 1022, MINNEAPOLIS, MN, 55440-1022, US

(21) Appl. No.: 11/957,260

(22) Filed: Dec. 14, 2007

Related U.S. Application Data
(60) Provisional application No. 60/939,945, filed on May 24, 2007.
(60) Provisional application No. 60/948,054, filed on Jul. 5, 2007.

(51) Int. Cl. H04M 1/66; H04M 3/16

(52) U.S. Cl. 455/411

(57) ABSTRACT

Messages are processed by receiving, from a first user on a wireless phone, a first message addressed to a second user. An extended header that is related to the first user and is for the first message is accessed. An alert is generated in response. A response to the alert from the second user is received. If the response includes an instruction from the second user to validate the message, a validation request is generated. The validation request is processed using a certificate authority. Based on a validation decision by the certificate authority for the validation request, a report for the second user with one or more processing options is generated. An instruction is received from the second user with a selection from among processing options. The first message is delivered to the second user if the instruction from the second user indicates that the message should be delivered.

### CROSS-REFERENCE TO RELATED APPLICATIONS

The application claims priority to U.S. Provisional Application No. 60/948,054, filed Jul. 5, 2007, entitled “A Mobile Commerce Service”, and U.S. Provisional Application No. 60/939,945, filed May 24, 2007, entitled “A Messaging Service.”

### TECHNICAL FIELD

This document relates to messaging systems.

### BACKGROUND

A variety of appliances are being used to exchange messaging communications. For example, a user may use SMS (“Short Message Service”) or MMS (“Multimedia Messaging Service”) application to exchange communications. In one instance, friends may use a SMS application on a wireless phone to exchange SMS messages with friends, In another instance, a parent with a camera phone may send a photo of a child's baseball game to a grandparent using a MMS application.

### DESCRIPTION OF DRAWINGS

FIG. 1 illustrates a user interface receiving a MMS message from an intermediary system.

FIG. 2 illustrates a user interface (UI) of a report that includes one or more processing options.

FIG. 3 illustrates a UI of a message that is presented to the receiving user.

FIG. 4A illustrates a UI of an enhanced messaging service application.

FIG. 4B illustrates a UI of a report indicating that a message from a sender has been validated.

FIG. 4C illustrates UI a message has been delivered to the receiving user.

FIG. 5 illustrates a UI indicating that the message cannot be validated.

FIG. 6 is a block diagram of a communications system that includes wireless phones and an intermediary system configured to interface with a wireless network infrastructure.

FIG. 7 is a flow chart of a process by which messages are exchanged.

### DETAILED DESCRIPTION

Users increasingly rely on wireless phones to perform important tasks. In addition to relying on wireless phones to provide a voice communications capability, many wireless phones also offer a messaging capability. For example, a phone may include a SMS (“Short Message Service”) and/or MMS (“Multimedia Messaging Service”) application that enables messages to be exchanged using a wireless phone.

As messaging services continue to be adopted, developers are exploring a variety of applications that use wireless messaging functionality. For example, a developer may be interested in developing e-commerce applications that rely on messaging protocols to pay for goods and services and, in response, transfer funds. However, merchants and consumers may not want to participate in a messaging-based transaction system if they do not have confidence in the source of the messages. In another environment, a user may have concerns about exchanging messages dealing with sensitive subject matter.

As a result, an intermediary system may process messages so that a participating user may have an increased degree of confidence as to the origins and content of an electronic message. More precisely, messages may be processed by receiving, from a first user on a wireless phone, a first message addressed to a second user. An extended header that is related to the first user and is for the first message is accessed. Based on accessing the extended header, an alert is generated, the alert being configured to prompt the second user for processing instructions for the first message. A response to the alert from the second user is received. If the response includes an instruction from the second user to validate the message, a validation request is generated. The validation request is processed using a certificate authority. Based on a validation decision by the certificate authority for the validation request, a report for the second user with one or more processing options is generated. An instruction is received from the second user with a selection from among processing options. The first message is delivered to the second user if the instruction from the second user indicates that the message should be delivered.

For example, a first user on a wireless phone may send a MMS message addressed to a second user. An intermediary system intercepts the message for specialized processing. For example, a message processing agent in a wireless carrier may designate one or more messages for special processing on a special processing server. In particular, an extended header for the first message is accessed. The extended header may include information related to the sending user (e.g., the sending user's phone number or wireless handset identifier) and may be supplemented with additional information based on identification information related to the sending user.

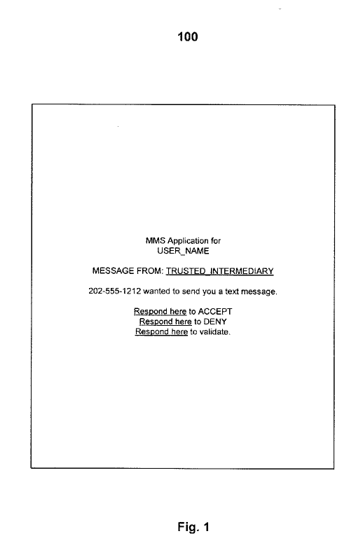

An alert is generated that is based on the extended header. For example, and as is shown in UI (“User Interface”) 100 in FIG. 1, the receiving user USER_NAME receives a MMS message from TRUSTED_INTERMEDIARY. TRUSTED_INTERMEDIARY represents an intermediary system that exchanges alerts and reports with a recipient user in order to determine whether the message should be delivered. UI 100 indicates that a user with handset identifier 202-555-1212 wants to send the second user a text message. The second user then has different options with which the recipient second user may respond. The second user can interact with one or more different hyperlinked options, for example, to accept, deny, or validate the text message. The recipient second user may respond to the alert by accepting the message, which will deliver the message to the second user without additional processing. The recipient second user also may deny the message to instruct the intermediary system to not deliver the message. The recipient user also may respond by instructing the intermediary system to validate the message.

Thus, in response to receiving the response to the alert from the second user, a validation request is generated. The validation request is processed using a certificate authority, for example, associated with the sending user and/or operated by a wireless carrier or other business entity (e.g., an online business certificate server).

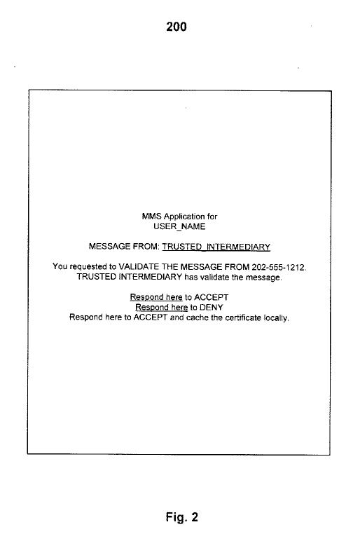

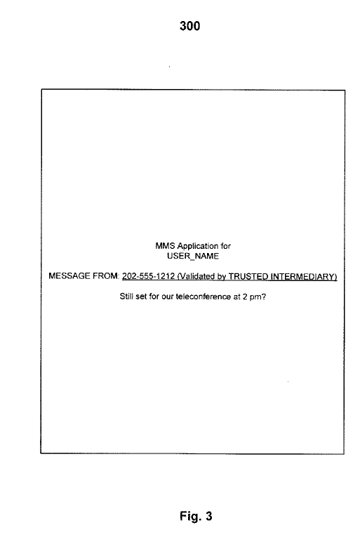

A report is generated that reflects the results of processing the validation request. FIG. 2 illustrates a UI 200 of a report that includes one or more processing options. UI 200 is sent by TRUSTED_INTERMEDIARY and indicates that the user has requested to validate the message from 202-555-1212. The report indicates that TRUSTED_INTERMEDIARY has validated the message. UI 200 then presents options to accept the message, deny the message, or to accept the message and cache the certificate locally. The second user then may select one of the options in order to instruct the trusted intermediary. If the second user has instructed the intermediary system to deliver the message, the intermediary system will deliver the message. In FIG. 3, UI 300 illustrates how the message may be presented to the second user. Specifically, UI 300 indicates that the message is from 202-555-1212, in contrast to the alert and report indicating origination from the TRUSTED_INTERMEDIARY (as was shown previously in UIs 100 and 200). UI 300 does indicate that the message has been validated by TRUSTED_INTERMEDIARY.

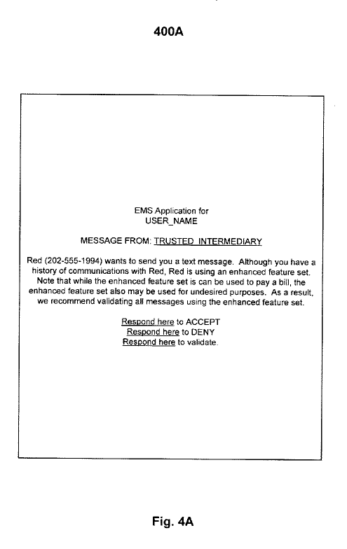

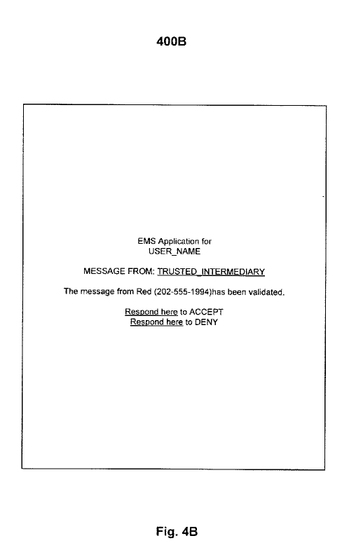

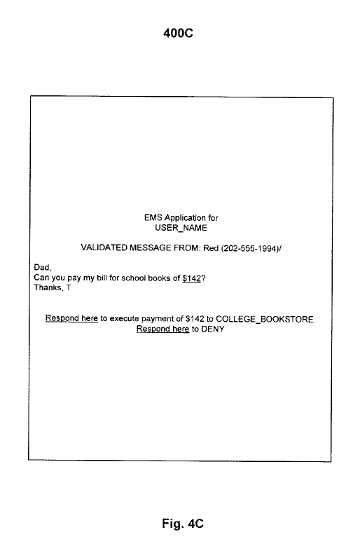

FIG. 4A illustrates a UI 400A of an enhanced messaging service application. UI 400 illustrates a message to USER_NAME from TRUSTED_INTERMEDIARY with an alert. In UI 400A, the TRUSTED INTERMEDIARY indicates that Red (a user identifier associated with phone number 202-555-1994) wants to send USER_NAME a message. UI 400A also indicates that despite a history of communications with Red, Red is sending USER_NAME a message with an enhanced feature set. UI 400A then communicates a warning relating to the enhanced feature set. UI400A indicates, “Note that while the enhanced feature set can be used to pay a bill, the enhanced feature set also may be used for undesired purposes. As a result, we recommend validating all messages using the enhanced feature set.” The recipient second user (USER_NAME) then is equipped to accept the message, deny the message, or validate the message. In FIG. 4B, UI 400B indicates that the message from Red has been validated. The second user is then prompted to accept or deny the message. In FIG. 4C, the message has been delivered and appears in UI 400C. In particular, Red appears to be asking his father to pay for a bill related to school books. The second user is then prompted to execute the payment of $145 or deny the charges.

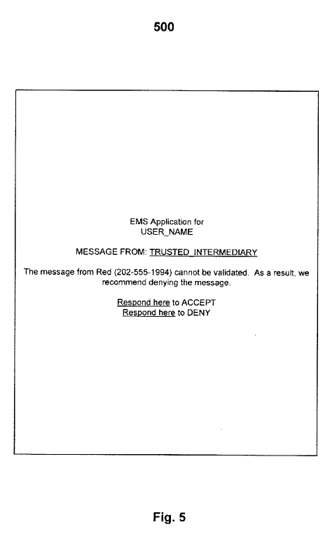

In contrast, and to illustrate a report where the message cannot be validated, FIG. 5 illustrates a GUI 500 indicating that the message from Red cannot be validated. The report in GUI 500 includes a recommendation to deny the message.

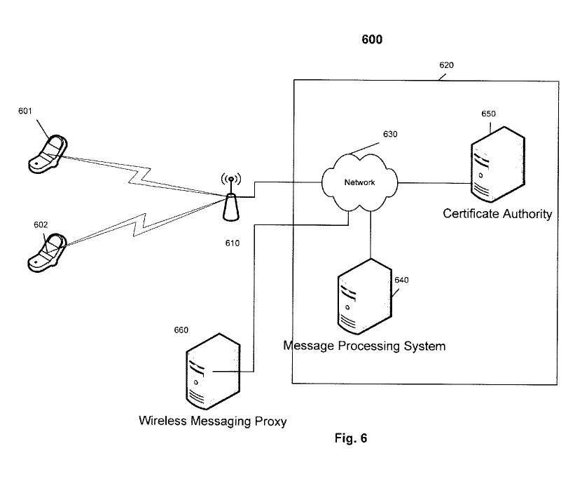

FIG. 6 is a block diagram of an exemplary communications system 600 where wireless phones 601 and 602 are configured to interface with a wireless infrastructure. Generally, wireless phones 601 and 602 display one or more UIs (e.g., the UIs described previously in FIGS. 1-5) to exchange messages using the wireless intermediary 620.

Each of the wireless phones 601 and 602 may include one or more devices capable of accessing a wireless network infrastructure 610 to exchange communications. The wireless phones may include one or more messaging applications.

In one implementation, the messaging application includes a messaging application that has been included by a manufacturer of a wireless phone. For example, a wireless manufacturer may develop a messaging application that works with other applications on the wireless phone (e.g., an address book application) in assisting users that are exchanging messages. The messaging application may include separately accessed modules for SMS and MMS applications. Alternatively, the messaging application may selectively invoke the appropriate messaging format (e.g., SMS vs. MMS) when format constraints call for a particular format to be used. For example, if the message is longer than 160 characters or includes an image, the messaging application may automatically format the message as a MMS message.

The messaging application also may include advanced modules that offer additional functionality beyond functionality required to exchange a SMS or MMS message. In one instance, the messaging application includes a certificate cache enabling a handset to perform its own certificate validation operations. For example, the message application may be configured to download automatically (or via user instruction) certificates for sending users with whom the receiving user has received communications. In particular, after a user has received a report indicating that a particular message has been validated, the user may be prompted to download the certificate for a particular user. The messaging application may be configured to then selectively download certificates in response to user instructions.

In another implementation, the messaging application may include modules that reduce the burden of responding to messages, alerts and reports. For example, the messaging application may be configured to determine that special terms appearing in a messaging application are “significant” in order to invoke advanced functionality. The messaging application may be configured to determine that the sending user's phone number represents a contact in an address book. As a result, the phone number may be replaced with the user's contact information from the address book. The receiving user then may select the contact information (e.g., name) to retrieve a list of one or more operations. The operations may include options to accept, deny or validate a message. The operations also may include enabling the receiving user to download the certificate for the user and perceiving a history of transactions with the sending user.

In yet another implementation, the messaging application links to other applications. For example, a messaging wallet application may be configured to use the validation functionality associated with the messaging application. In particular, the messaging wallet application may be configured to interface with an intermediary system in order to transfer funds from a user's line of credit to a merchant's accounts receivable. A consumer attempting to purchase goods or services from a merchant may provide an identifier (e.g., the consumer's phone number) using a retail point of sale system. The retail point of sale system may initiate a transaction sequence that results in a message being transmitted to the consumer's wireless phone. A messaging wallet application on the wireless handset then may be configured to interact with the intermediary system through a series of alerts, reports and responses exchanged using wireless messaging protocols.

In still another implementation, a validated message may be delivered in a secure manner, for example using a public key infrastructure (“PKI”). After validating the source of an incoming message from a first user, encryption keys may be exchanged between the first user transmitting handset, the certificate authority, and the second user receiving handset, consistent with a PKI encryption model. Alternatively, encryption keys can be exchanged as a separate message. Keys can also be included in the extended header information alerting the second user of the incoming SMS/MMS message. After keys have been exchanged between the first user handset, the certificate authority, and the second user handset, encrypted messages may be exchanged using the same accept-deny-validate protocol discussed above, or may be delivered directly.

Although SMS and MMS protocols were described in various implementations, other wireless messaging protocols may be used. For example, a wireless carrier may implement different wireless protocol that relies on a different wireless format and/or includes different wireless features.

In one implementation, the wireless phones 601 and 602 include one or more information retrieval software applications (e.g., a browser, a mail application, an instant messaging client, an Internet service provider client, a media player, or an integrated client) capable of receiving one or more data units. The information retrieval applications may run on a general-purpose operating system and a hardware platform that includes a general-purpose processor and specialized hardware for graphics, communications and/or other capabilities. In another implementation, the wireless phones 701 and 702 may include a wireless telephone running a micro-browser application on a reduced operating system with general purpose and specialized hardware capable of operating in mobile environments.

Each of the wireless phones 601 and 602 exchange communications with other devices using the wireless network infrastructure 610. The wireless network infrastructure may include, for example, a CDMA (“Code Division Multiple Access”) network or a TDMA (“Time Division Multiple Access”) network.

The wireless network infrastructure 610 includes systems and controllers that are configured to enable wireless phones (and other wireless messaging systems) to exchange communications. In one implementation, the wireless network infrastructure 610 includes the wireless towers, points-of-presence, switching centers, handoff controllers, billing systems, and other systems that provide a wireless phone with seamless connectivity to a wireless network.

The intermediary system 620 includes a communication infrastructure configured to facilitate the exchange of messages between users of the wireless network infrastructure 610, and also with peripheral systems (e.g., a merchant using wireless messaging proxy 660). The intermediary system 620 includes a network 630, a message processing system 640, and a certificate authority 650. In addition, the intermediary system 620 also is configured to exchange communications with the wireless messaging proxy 660.

The intermediary system 620 may be configured to receive messages from, for example, wireless phone 601 that are addressed to wireless phone 602. Within the intermediary system 620, the message processing system 640 is configured to process messages that have been received. The messaging proxy may designate one or more messages as enhanced messages that, in turn, involve exchange of alerts and reports between a recipient user and a sending user as to whether a message should be delivered to the sending user.

Each of the message processing system 640, certificate authority 650, and the wireless messaging proxy 650 may be implemented by, for example, a general-purpose computer capable of responding to and executing instructions in a defined manner, a personal computer, a special-purpose computer, a workstation, a server, a device, a component, other equipment or some combination thereof capable of responding to and executing instructions. These systems may be configured to receive instructions from, for example, a software application, a program, a piece of code, a device, a computer, a computer system, or a combination thereof, which independently or collectively direct operations, as described herein. The instructions may be embodied permanently or temporarily in any type of machine, component, equipment, or storage medium that is capable of being delivered to the message processing systems 640, certificate authority 650, and the wireless messaging proxy 650.

The intermediary system 620 may include and/or form part of an information delivery network, such as, for example, the Internet, the World Wide Web, an online service provider, and/or any other analog or digital wired and/or wireless network that provides information. Such information delivery networks may support a variety of online services, including Internet and/or web access, e-mail, instant messaging, paging, chat, interest groups, audio and/or video streaming, and/or directory services.

In one implementation, the intermediary system 620 includes one or more message exchanging applications for accessing and transmitting messages within the wireless network infrastructure 610. The message exchanging applications may run on a general-purpose operating system and a hardware platform that includes a general-purpose processor and/or specialized hardware. Another implementation may include a reduced operating system with both general purpose and specialized hardware to operate in mobile environments.

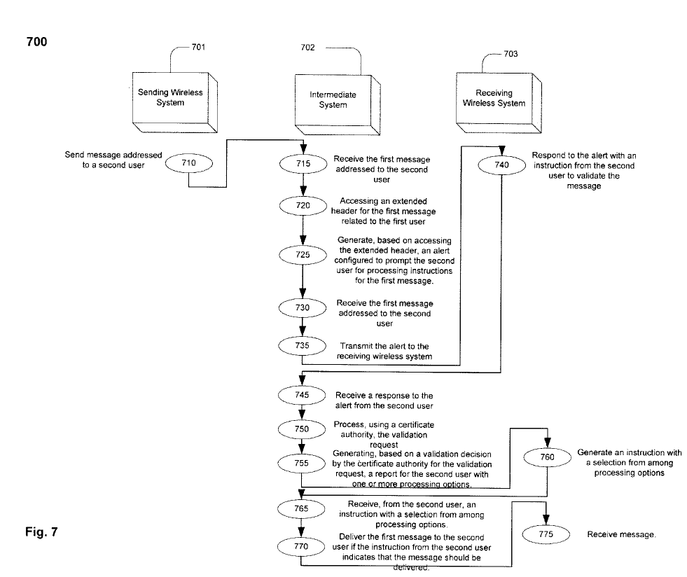

The message processing system 640 includes a system that processes messages originating from and sent to wireless phones 601 and 602 and other wireless devices in the wireless messaging system. The message processing system 640 may include a screening controller that selectively routes messages for additional processing. For example, the message processing system 640 may be configured to place messages from merchants requesting payment into a special queue. The messages in the special queue then may be processed using special procedure (e.g., the operations shown in FIG. 7) that increase the confidence of the intermediary and user that the transactions are valid. The message processing system 640 may selectively route messages based on the source address of the sender, the destination address of the recipient, and/or based on the contents of the message that indicate the message relates to processing a financial transaction.

The certificate authority 650 includes a system structured and arranged to host and validate digital certificates. The certificate authority 650 may be configured to enable users to access digital certificates for wireless subscribers and other nodes in the wireless network (e.g., merchants using a wireless messaging proxy). In one implementation, the digital certificate include the identity of a wireless subscriber (e.g., name and/or phone number), the public key for the individual being signed, a validity period, and the digital signature of the certificate produced by the certificate authority's private key.

In another implementation, the certificate server is configured to delegate to subordinate or different certificate authorities located external to the intermediary system 620. For example, the certificate authority 650 may be configured to delegate to a corporation's servers communications that involve the corporation's employees.

The network 630 includes hardware and/or software capable of enabling direct or indirect communications between the devices on the wireless network infrastructure 610 (e.g., wireless phones 601 and 602) and the devices within the intermediary system 620. As such, the network 420 may include a direct link between the wireless network infrastructure 610 and the intermediary system 620, or it may include one or more networks or sub networks between them (not shown). Each network or sub network may include, for example, a wired or wireless data pathway capable of carrying and receiving data. Examples of the delivery network include the Internet, the World Wide Web, a WAN (“Wide Area Network”), a LAN (“Local Area Network”), analog or digital wired and wireless telephone networks, radio, television, cable, satellite, and/or any other delivery mechanism for carrying data.

The wireless messaging proxy 660 includes a system that is configured to interface with a wireless messaging system using wireless messaging protocols. The wireless messaging proxy 660 may include a landline-based system that exchanges communications with the intermediary system 620 in order to communicate with wireless phones and/or other wireless messaging proxies. In one implementation, the wireless messaging proxy is configured to interface with a retail point-of presence located at a merchant.

FIG. 7 is a flow chart 700 of a process by which messages are exchanged. More precisely, flow chart 700 illustrates how an intermediary system exchanges alerts and reports with a user on a receiving wireless phone in order to determine whether the message should be delivered. Typically, the operations performed in flow chart 700 are performed on the systems described previously with respect to FIG. 6 and using the UIs described previously with respect to FIGS. 1-5. However, other systems and UIs may be used to exchange messages.

Initially, a first user on a sending wireless phone 701 sends a message addressed to a second user (710). For example, a first user may send a MMS message to a friend that is the second user on the receiving wireless phone 703. The MMS message may be addressed to the second user using the phone number on the second wireless phone. The intermediary system 702 receives, from the first user on the sending wireless phone 701, a first message addressed to a second user (715). For example, the intermediary system 702 may be configured to receive MMS messages from subscribers for a particular wireless carrier, charge the subscriber for the cost of the message, and transmit the MMS message to the recipient if the message is authorized (e.g., paid for and supported by message processing instructions).

The intermediary system 702 then accesses an extended header for the first message related to the first user (720). In one implementation, accessing the extended header includes identifying header information from a message that is received by the intermediary system. In another implementation, accessing the header includes referencing information related to the sender (as identified by device identification information from the received message).

The intermediary system 702 generates, based on accessing the extended header, an alert configured to prompt the second user for processing instructions for the first message (725). For example, the intermediary system 702 may generate an alert indicating that the sending wireless phone 701 associated with a particular telephone number wishes to send the message to receiving wireless phone 703. The intermediary system 702 may use call signaling information (e.g., the phone number of the sending system) and reference a database (or network-based address book for the receiving wireless phone 703) to provide additional information descriptive of the sending user (e.g., name and/or address information). In one implementation, the intermediary system 702 generates a label descriptive of past interactions with the user. For example, the intermediary system may include a “FAMILIAR” label in the subject of a MMS message for those users with which the user has exchanged at least a threshold number of messages or engaged in a threshold number of transactions.

The alert is then transmitted to the receiving wireless phone 703 (735). In one implementation, the alert is sent as a MMS message originating from the intermediary system 702. The alert may be formatted to simplify the burden on a user in responding, for example, by reducing the number of keys required by a user to respond to the alert. In one configuration, the alert may be formatted with hyperlinked fields that instruct intermediary system 702 how to respond. The hyperlinked fields may be generated by the intermediary system, or by a messaging application on the receiving wireless phone 703 that processes specified terms (e.g., “validate”) from specified senders (e.g., the receiving wireless phone 703) in a particular manner (e.g., by presenting the term “validate” as a selectable command).

The receiving wireless phone 703 then responds to the alert with an instruction from the second user to validate the message (740). For example, the user may respond to a message and type in the term, “validate.” Alternatively, the user may respond with an instruction to “deny” delivery or “deliver” a message. The intermediate system 702 then receives the response to the alert from the second user (745). In one implementation, the response includes a parameter descriptive of the instruction (e.g., a “1” to accept, a “2” to deny, a “3” to validate, a “4” to report message as suspicious, and a “5” for request help). The intermediary system 702 then may use the received parameter to instruct a messaging processing system in response. In another implementation, the intermediary system 702 is configured to analyze a message sent in response and determine if the response includes a term with special meaning (e.g., validate).

The intermediary system 702 generates, if the response includes an instruction from the second user to validate the message, a validation request (750). For example, the intermediary system 702 may encapsulate the message from the first user in a larger message and route the larger message to a certificate server for processing. The validation request is then processed using a certificate authority (755). Based on a validation decision by the certificate authority for the validation request, a report is generated for the second user with one or more processing options (760). In one implementation, the report includes an indication of whether the message has been validated, and options to deny or deliver the message. The receiving wireless phone 703 generates an instruction with a selection from among the processing options (760). More precisely, if the intermediary system 702 indicates that the message has been validated, the recipient user uses the receiving wireless phone 703 to indicate that the message should be delivered. The intermediary system 702 then receives, from the second user, an instruction with a selection from among the processing options (765). For example, the intermediary system 702 may receive a SMS message from the receiving wireless phone 703 indicating that the message should be delivered. The intermediary system 702 then delivers the first message to the second user if the instruction from the second user indicates that the message should be delivered (770). In one implementation, delivers the first message to the second user includes releasing a SMS message from a queue on a message processing system so that the SMS message may be delivered. The receiving wireless phone then receives the message (775).

Other implementations are within the scope of the following claims. For example, the operations need not be performed by wireless phones. A variety of other systems (e.g., messaging proxies) may be used to perform the operations described herein. For example, a merchant may operate a proxy messaging server that exchanges messages with customers, some of whom may be using wireless phones, using a wireless messaging protocol. Thus, the proxy messaging server may send messages to a customer's wireless phone in order to execute the transaction.

What is claimed is:

1. A method of processing messages, the method comprising:
receiving, from a first user on a wireless phone, a first message addressed to a second user;
accessing an extended header for the first message related to the first user;
generating, based on accessing the extended header, an alert configured to prompt the second user for processing instructions for the first message;
receiving a response to the alert from the second user;
generating, if the response includes an instruction from the second user to validate the message, a validation request;
processing, using a certificate authority, the validation request;
generating, based on a validation decision by the certificate authority for the validation request, a report for the second user with one or more processing options;
receiving, from the second user, an instruction with a selection from among processing options; and
delivering the first message to the second user if the instruction from the second user indicates that the message should be delivered.

2. The method of claim 1 wherein accessing the extended header includes accessing the extended header that has been received in the first message from the wireless phone.

3. The method of claim 1 wherein accessing the extended header includes:
accessing the extended header by referencing information related to the first user from an intermediary system,
generating, based referencing information related to the first user, the extended header; and
associated the extended header with the first message.

4. The method of claim 1 wherein receiving the message includes:
inspecting the message addressed to the second user;
determining that the message should be routed through an intermediary;
routing, based on the determination that the message should be routed through an intermediary, the message to an intermediary for processing; and
selectively delivering the message to the second user based on processing performed by the intermediary.

5. The method of claim 4 further comprising using a intermediary to process the message without permitting first user to perceive the status of communications between intermediary and the second user.

6. The method of claim 1 wherein accessing the extended header includes accessing a user identifier.

7. The method of claim 1 wherein generating the alert includes generating a second message addressed to the second user that appears to originate from a different entity than the first user.

8. The method of claim 1 wherein generating the alert includes generating a second message descriptive of the first message.

9. The method of claim 1 wherein generating the alert includes prompting the second user with a second message with processing instructions to accept the first message; deny the first message, or validate the first message.

10. The method of claim 1 wherein generating the validation request includes referencing certificate information for the first user included in the extended header and transmitting the certificate information for the first user to the certificate authority.

11. The method of claim 1 wherein generating the report includes transmitting, to the second user, an indication of whether the certificate authority validated the first message.

12. The method of claim 1 wherein receiving, from the second user, the instruction includes receiving a deny instruction indicating that the first message should not be delivered to the second user.

13. The method of claim 1 further comprising enabling the second user to cache certificate information for the first user local to the second user.

14. The method of claim 1 further comprising receiving an instruction from the second user to automatically validate all messages using the certificate authority.

15. The method of claim 1 further comprising receiving an instruction from the second user to automatically validate all messages from the first user using the certificate authority.

16. A computer program on a computer readable medium comprising instructions that when executed on a processor cause the processor to:
receive, from a first user on a wireless phone, a first message addressed to a second user;
access an extended header for the first message related to the first user;
generate, based on accessing the extended header, an alert configured to prompt the second user for processing instructions for the first message;
receive a response to the alert from the second user;
generate, if the response includes an instruction from the second user to validate the message, a validation request;
process, using a certificate authority, the validation request;
generate, based on a validation decision by the certificate authority for the validation request, a report for the second user with one or more processing options;
receive, from the second user, an instruction with a selection from among processing options; and
deliver the first message to the second user if the instruction from the second user indicates that the message should be delivered.

17. A system comprising:
means for receiving, from a first user on a wireless phone, a first message addressed to a second user;
means for accessing an extended header for the first message related to the first user;
means for generating, based on accessing the extended header, an alert configured to prompt the second user for processing instructions for the first message;
means for receiving a response to the alert from the second user;
means for generating, if the response includes an instruction from the second user to validate the message, a validation request;
means for processing, using a certificate authority, the validation request;
means for generating, based on a validation decision by the certificate authority for the validation request, a report for the second user with one or more processing options;
means for receiving, from the second user, an instruction with a selection from among processing options; and
means for delivering the first message to the second user if the instruction from the second user indicates that the message should be delivered.
